(19) United States
(12) Patent Application Publication
(10) Pub. No.: US 2015/0019234 A1
(43) Pub. Date: Jan. 15, 2015

(54) ELECTRONIC MEDICAL PROCESSING, ANALYSIS, AND STORAGE SYSTEM AND METHODS THEREOF

(71) Applicants: Michele I. Cooper, Short Hills, NJ (US); Justin L. Cooper, Short Hills, NJ (US)

(72) Inventors: Michele I. Cooper, Short Hills, NJ (US); Justin L. Cooper, Short Hills, NJ (US)

(21) Appl. No.: 13/940,120

(22) Filed: Jul. 11, 2013

(51) Int. Cl. G06Q 50/22; G06Q 10/06

(52) U.S. Cl. CPC G06Q 50/22; G06Q 10/06393
USPC 705/2

(57) ABSTRACT

A computer-implemented method and system for electronic medical processing, analysis, and storage is provided. In one embodiment, a computer-implemented method for collecting and analyzing medical data may include at a server having one or more processors and memory storing one or more programs for execution by the one or more processors: receiving medical data related to a medical procedure from a data collection member; comparing the medical data with a range of best practices data; determining if the received medical data conforms to the range of best practices data; generating an alert if the medical data does not conform to the range of best practices data; and storing the medical data in a database.

### BACKGROUND

1. Field of the Invention

Embodiments of the present invention are generally related to electronic medical processing, analysis, and storage systems and methods thereof. More specifically, embodiments of the present invention relate to computer-implemented systems and methods for capturing and/or analyzing data relating to a medical procedure or a medical treatment and providing a detailed, easy to access, electronic account of every medical procedure.

2. Description of the Related Art

Global healthcare costs have continued to skyrocket for many years and health insurance premiums are at an all-time high. Health insurance premiums have more than doubled recently, at a rate three times faster than cumulative wage increases. The United States alone spent approximately $2.2 trillion on health care in 2007, or $7,421 per person. The reasons for this substantial increase in healthcare costs in the recent past is that people living longer with unhealthy habits. The average American today has a life expectancy of 77.7 years, while as recently as the early 70's life expectancy was under 70, and many people must be treated for chronic diseases created by unhealthy habits. Chronic diseases account for 75% of all healthcare costs. About half the cost of treating chronic diseases are attributable to unhealthy habits such as smoking and/or unhealthy diets.

In addition to the increase in the number of people requiring healthcare for longer periods of time, misuse or wasteful healthcare spending also contributes to the high cost of healthcare. In the U.S., misuse or wasteful healthcare spending accounts for more than half of all health care spending (approx. $1.2 trillion). Some of this wasteful spending is a result of defensive medicine, and some is directly attributable to consumers who seek unnecessary medical attention.

Further, medical errors have also contributed to the high cost of healthcare. In the U.S., one in five Americans report that they or a family member have experienced a medical error of some kind. An estimated 22.8 million people in the U.S. have at least one family member who experienced a mistake in a doctor's office or hospital. According to some studies, medical errors rank as the eighth leading cause of death in the United States—higher than motor vehicle accidents (43,458), breast cancer (42,297), or AIDS (16,516). A large number of people in the U.S. die due to potentially preventable, in-hospital medical errors. Some studies suggest that 40,000 incidences of harm occur from medical errors in U.S. hospitals every day. Patient safety and preventing medical errors is a serious public health issue.

Medical malpractice lawsuits have also contributed to the high cost of healthcare worldwide. In the U.S. specifically, approximately 195,000 people are killed every year by alleged medical errors, and between 15,000 and 19,000 malpractice suits are brought against doctors in the U.S. each year. Litigation costs of malpractice suits have been increasing substantially every year since 1975. The overhead cost of malpractice litigation is exorbitant, for every dollar spent on compensation, typically more than half is allocated to administrative expenses (e.g., legal services, experts, courts, or the like). Claims involving errors accounted for 78% of administrative expenses.

In order to protect themselves against medical malpractice lawsuits, many physicians today practice “defensive” medicine, ordering medical tests, procedures, or consultations of doubtful clinical value. Many doctors also forego high-risk procedures such as setting broken bones, delivering babies, or the like, because the risk of litigation is higher in these areas. Unnecessary tests due to “defensive” medicine account for a large portion of healthcare costs. As much as $650 billion per year, or $1 of every $4 spent on healthcare each year, is spent on unnecessary tests and treatments ordered by physicians solely to protect themselves against lawsuits. These unnecessary result in higher malpractice insurance premiums.

As a potential solution, legislators in the U.S. have proposed tort reform measures limiting medical malpractice lawsuits. However, none of the measures taken by legislators have significantly decreased the practice of defensive medicine. The current litigation system is adversarial, expensive and inefficient.

Thus, a need exists for a system that significantly reduces costs for all parties (patients, healthcare providers, insurance companies, or the like), improves physician confidence to administer only the appropriate and best care for their patients, and quickly and effectively reduces and resolves malpractice claims.

### SUMMARY

Embodiments of the present disclosure relate to electronic medical processing, analysis, and storage systems and methods thereof. In one embodiment, a computer-implemented method for collecting and analyzing medical data may comprise, at a server having one or more processors and memory storing one or more programs for execution by the one or more processors, receiving medical data related to a medical procedure from a data collection member; comparing the medical data with a range of best practices data; determining if the received medical data conforms to the range of best practices data; generating an alert if the medical data does not conform to the range of best practices data; and storing the medical data in a database.

In another embodiment of the present disclosure, a computer-implemented method for collecting and analyzing medical data may comprise, at a client having one or more processors and memory storing one or more programs for execution by the one or more processors, receiving medical data related to a medical procedure from a data collection member; comparing the medical data with a range of best practices data; determining if the received medical data conforms to the range of best practices data; generating and displaying an alert if the medical data does not conform to the range of best practices data; and transmitting medical data to a server for storage on a database.

In yet another embodiment of the present disclosure, a system is provided that may comprise at least one server, the server comprising one or more processors; and memory; wherein the at least one server is configured to receive medical data related to a medical procedure from a data collection member; compare the medical data with a range of best practices data; determine if the received medical data conforms to the range of best practices data; generate an alert if the medical data does not conform to the range of best practices data; and store the medical data in a database.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of an electronic medical data processing, analysis, and storage system in accordance with embodiments of the present invention;

FIG. 2 depicts a block diagram of a general computer system, which is capable of being used in connection with the system depicted in FIG. 1, in accordance with embodiments of the present invention;

FIG. 3 depicts a block diagram of an electronic medical processing. analysis, and storage system in accordance with embodiments of the present disclosure;

FIG. 4 is depicts a top view of a treatment area in accordance with embodiments of the present invention;

FIG. 5 depicts an exemplary client computer capable of being used with the system depicted in FIG. 1, in accordance with embodiments of the present invention; and

FIG. 6 depicts a flow diagram illustrating an exemplary method for electronic medical data processing, analysis, and storage in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to electronic medical processing analysis and storage systems and methods thereof. More specifically, embodiments of the present invention relate to computer-implemented systems and methods for capturing and/or analyzing data relating to a medical procedure or a medical treatment and providing a detailed, easy to access, electronic account of every medical procedure.

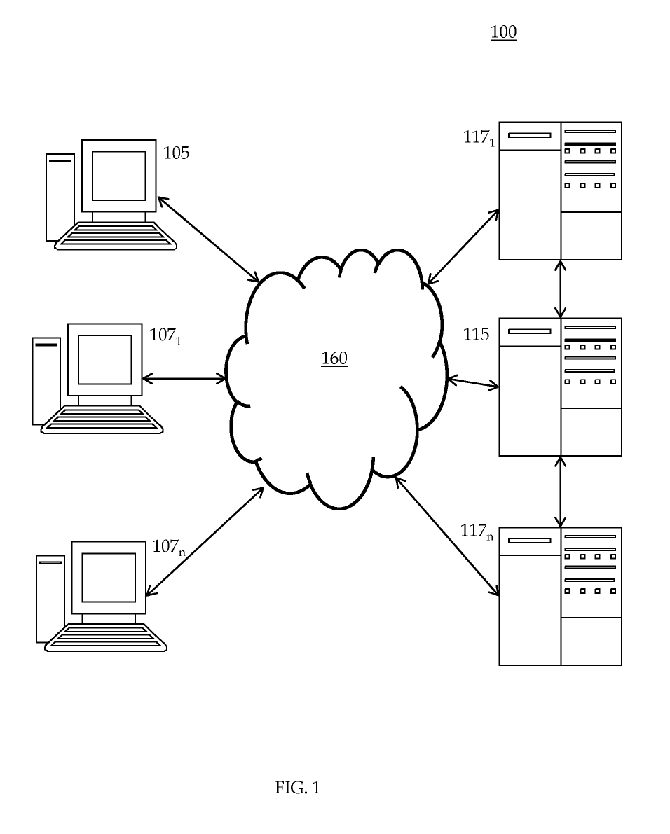

FIG. 1 depicts a system-level network diagram of an electronic medical data processing, analysis, and storage system 100 in accordance with embodiments of the present invention. In exemplary embodiments, the system 100 may be adapted to capture, transmit, analyze, filter, review, and/or archive all information relating to a medical procedure and providing a detailed, easy to access, electronic account of every medical procedure. In accordance with embodiments of the present invention, information may be collected from multiple data sources and transmitted to a central repository where the data may be aggregated, filtered, and flagged for immediate review, or archived for future retrieval based on an algorithmic score. Embodiments of the present invention may generally provide alerts and/or notifications of possible incidences of medical error, and may lead to more accurate predictability of medical malpractice litigation outcomes, providing numerous benefits to patients, healthcare providers, payers, and/or the like.

In accordance with exemplary embodiments, the system 100 generally comprises at least a first client 105, generally in communication with a server 115 via a network 160. In some embodiments, the system 100 may comprise secondary clients 107₁ and 107ₙ. The clients may be in communication with the host server 115, generally through the network 160.

As used herein, the terms “patient” and “patients” may refer to one or more individuals seeking medical attention and/or treatment. As used herein, the term “healthcare provider” may refer to an individual or institution that provides preventative, curative, promotional, and/or rehabilitative health care services to individuals, families, or communities. Healthcare providers may include an individual or institution in the field of medicine, nursing, dentistry, optometry, pharmacy, allied health professions, and/or the like. For example, a “healthcare provider” may refer to a medical doctor, a nurse, a nurse practitioner, a physician's assistant, a dentist, a dental hygienist, a dental assistant, a psychologist, a psychiatrist, a counselor, a physical therapist, an athletic trainer, a healthcare technician, a chiropractor, a dietitian, a health educator, a hospital administrator, a home health aide, a licensed practical nurse, an ophthalmologist, an optician, an optometrist, a pharmacist, a podiatrist, a respiratory therapist, a veterinarian, a hospital, a medical office, a clinic, and/or the like.

As used herein, the term “payer” may refer to an individual or institution in the field of healthcare coverage. For example, a payer may include private health insurance companies, government programs for providing healthcare coverage, other individuals or entities that provide healthcare coverage, and/or the like. As used herein, the terms “vitals” or “vital signs” may refer to measures of various physiological statistics taken in order to assess body functions. For example, some vitals or vital signs may include body temperature, pulse rate, blood pressure, respiratory rate, and/or the like. As used herein, the term “medical data,” may refer to any data related to the healthcare of the patient. For example, medical data may include a patient's height, weight, sex, age, ethnicity, personal medical history, family medical history, prescribed medications, prior medical procedures, prior test results, and/or the like. As used herein, the term “administrator” may refer to any user with administrative access to the systems and methods in accordance with embodiments of the present invention. As used herein, the term “medical procedure” may refer to any treatment, treatment plan, diagnosis, prognosis, or the like provided to a patient. For example, a medical procedure may comprise an invasive surgery, a non-invasive procedure, a therapeutic procedure, a radiation therapy, chemotherapy, dialysis, administering or prescribing a medication, any action taken to improve or treat any medical condition of a patient, and/or the like.

A system 100 in accordance with embodiments of the present invention may provide various benefits to patients. Patients may be provided with access to a confidential summary of data related to any medical procedure performed on the patient, allowing them to understand what occurred. In accordance with exemplary embodiments, the system 100 may be adapted to provide the patient with their vital signs during the procedure, a complete video and audio record of the procedure retrieved from the treatment area, a record of any “abnormalities” occurring during the procedure, documentation of all activities taking place during the procedure, and/or the like. As such, the system 100 may be adapted to provide data and/or answers to questions the patient may have while improving medical care by keeping complete and accurate records of medical procedures. If a system 100 in accordance with embodiments of the present disclosure is utilized, patient costs may generally decrease due to the increased accuracy of diagnosis and treatment of the patients from the more complete medical records.

In addition to reducing healthcare costs for patients, healthcare providers may also benefit from a system 100 in accordance with the present invention. Healthcare providers may benefit by receiving a complete record of medical procedures in an easy to access electronic file and documentation/evidence of the procedure supporting appropriate activities taken. By utilizing a system 100 in accordance with embodiments of the present invention, healthcare providers may improve their ratings and reputation by alerting prospective patients that all medical procedures are monitored and quality controls are implemented to replace ineffective employees. Having a complete record of medical procedures may also result in a significant reduction of “frivolous” malpractice lawsuits because the healthcare providers would be able to dismiss these “frivolous” lawsuits more easily with a complete and accurate record demonstrating the lack of a healthcare error.

As such, a system 100 in accordance with embodiments of the present invention may allow a healthcare provider to effectively and economically refute and defend against any/all allegations or claims of malpractice. Accordingly, use of a system 100 in accordance with embodiments of the present invention may result in a significant reduction in insurance costs because a high percentage of premium payments are related to defending malpractice lawsuits. A system 100 in accordance with the present invention may allow healthcare providers to maintain complete records of all patient procedures, thereby allowing medical professionals to make more accurate diagnoses and eliminate the need for unnecessary tests and reducing costs. In addition, the healthcare provider's rating and reputation would be increased due to the emphasis placed on patient protection through monitoring of medical procedures. A system 100 in accordance with embodiments of the present invention would also allow healthcare institutions to reduce the number of healthcare professionals susceptible to medical mistakes, and to attract the most qualified healthcare professionals due to the institution's increased reputation as a result of using the system 100.

A system 100 in accordance with the present invention may also provide benefits to payers. A system 100 in accordance with the present invention may be adapted to provide payers with a complete record of all medical procedures in an easy to access electronic file. These complete records may provide the payer with easy to access documentation/evidence of any abnormalities occurring during a procedure. With complete records of a procedure, payers may benefit from a significant reduction in “frivolous” malpractice law suits. A system 100 in accordance with embodiments of the present invention may also result in a significant reduction in the cost of litigation associated with illegitimate patient claims due to the ability to more easily dispose of the lawsuits due to more complete evidence indicating no medical error occurred.

A system 100 in accordance with embodiments of the present invention may also provide the payers with a warning that a medical error has occurred, encouraging pro-active early settlement of legitimate claims. As such, a system 100 in accordance with embodiments of the present invention may result in the ability to reduce costs and provide more competitive insurance coverage/rates to healthcare providers and patients. A system 100 in accordance with embodiments of the present invention may also reduce the need for healthcare providers to practice “defensive medicine”, reducing the overall costs of healthcare. A provider of a system 100 in accordance with embodiments of the present invention may profit from the system 100 by charging parties a fixed fee for a time period, charging per patient, charging per procedure, charging per amount of data required, charging per report generated, charging per time taken to use the system, and/or the like.

Methods in accordance with embodiments of the present invention may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 (“Wi-Fi”) protocol, cellular data protocol (e.g., EDGE, CDMA, TDMA, GSM, LTE), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

Although FIG. 1 depicts two secondary clients 107₁ and 107n, it should be appreciated that “n” represents any number of clients feasible in accordance with embodiments of the present disclosure. For ease of reference, as used herein, the term “client” may refer to any one or all of the clients, 105, 107₁, and 107ₙ within the system 100. That is, in certain embodiments, multiple clients may perform the same or similar functions. For ease, one client 105 will be referred to herein, however in exemplary embodiments, more than one client 105 may be included in the system 100.

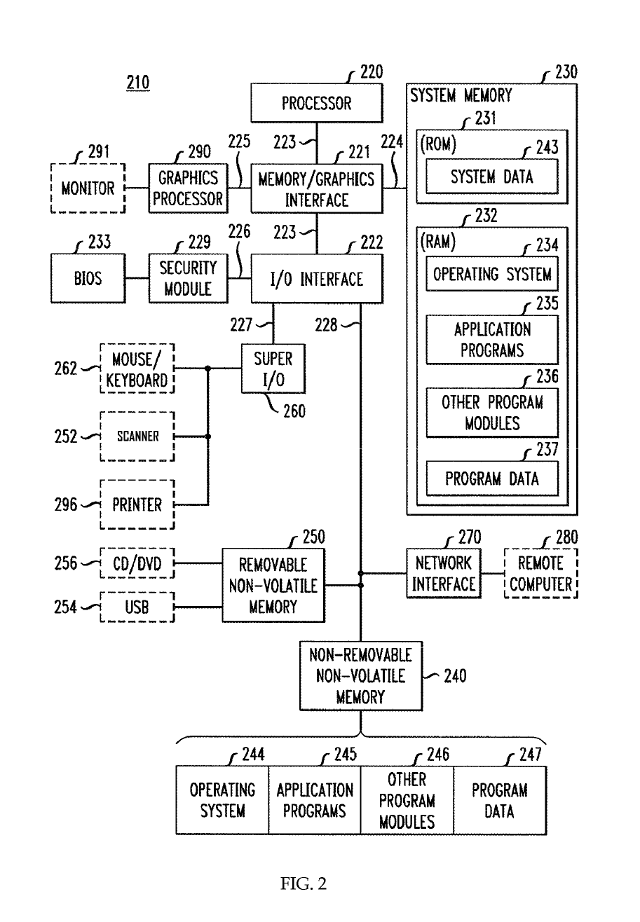

As used herein, the term “computer” may generally refer to any device that is capable of processing a signal or other information. Examples of computers include, without limitation, a personal computer, a portable computer, a handheld computer, a cellular phone, a smart phone, a digital tablet, a laptop computer, a netbook, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer, as discussed below with respect to FIG. 2. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

The client 105 may generally comprise a communications device, such as a computer. In a basic exemplary embodiment, within the system 100, the client 105 may be capable of transmitting data to and from a host server 115. The host server 115 may host an accessible data portal (e.g., a website or the like). The accessible data portal, which may be accessible to the client 105, may communicate with the client 105 through the network 160. The accessible data portal may comprise any number of security measures to provide a reasonably secure system, suitable for embodiments of the present disclosure. The accessible data portal may further comprise a graphical client interface (GUI) through which a client 105 may access the server 115.

The system may also comprise secondary servers 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one or all of the servers, 115, 117₁, and 117ₙ within the system 100. That is, in certain embodiments, multiple servers may perform the same or similar functions.

The server 115 may also comprise a database or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first client 105, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or clients may comprise a general purpose computer, for example, as shown in the form of a computer 210 depicted in FIG. 2.

FIG. 2 depicts a block diagram of a general computer system, which is capable of being used in connection with the system depicted in FIG. 1, in accordance with embodiments of the present disclosure. As appreciated by embodiments of the present disclosure, mobile devices, such as mobile telephones, tablets, netbooks, or the like, may be utilized instead a general computer 210 for embodiments of the present disclosure. However, it is also appreciated there is a significant similarity in core components between a mobile device and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD), blue-ray or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up. In some embodiments, a security module 229 may be incorporated to manage metering, billing, and enforcement of policies. The security module 229 may comprise any security technology suitable for embodiments disclosed herein.

A super input/output chip 260 may be used to connect to a number of peripherals, such as a scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace. In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A client may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure.

It is understood by embodiments of the present disclosure that a computer, such as the one depicted in FIG. 2, may be connected to a computer network or system. A computer network may include the Internet, a global computer network, an internal computer network, dedicated server networks, or the like.

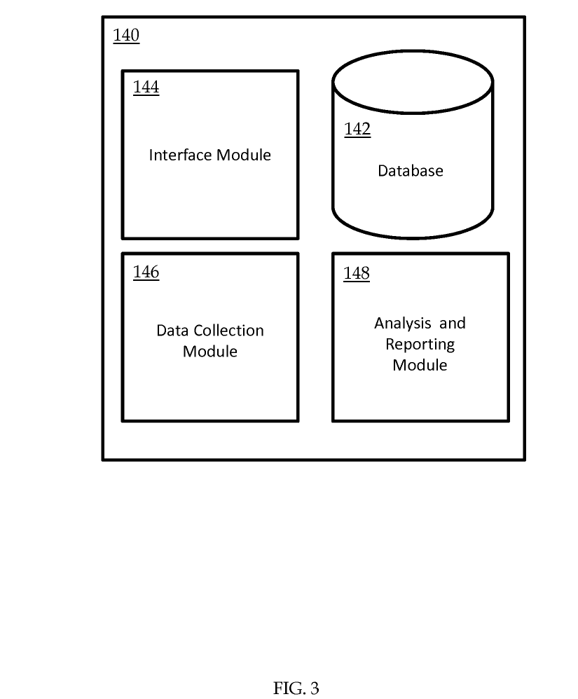

FIG. 3 depicts a block diagram of an electronic medical processing, analysis, and storage system 140 (hereinafter, “EMPASS”) in accordance with embodiments of the present invention. The EMPASS 140 may generally comprise computer executable software and/or instructions configured to perform the functionality of the systems and methods disclosed herein. The EMPASS 140 may be stored on a server, on a local computing device, on a mobile communications device, and/or the like. The EMPASS 140 may comprise a database 142, an interface module 144, a data collection module 146, an analysis and reporting module 148, and/or the like. In accordance with exemplary embodiments of the present invention, any module may be merged and/or combined with any other module. In some embodiments, additional or fewer modules than those depicted in FIG. 3 may be included.

In exemplary embodiments, the EMPASS 140 may be configured to capture, analyze, and store all essential information relating to a medical procedure. The EMPASS 140 may be adapted to collect healthcare data via one or more data sources, receive the healthcare data from the one or more sources, analyze healthcare data, generate alerts if the healthcare data meets a predetermined condition, store at least a portion of the healthcare data, and present a report to a user. In some embodiments, the EMPASS 140 may be configured to provide real-time or substantially real-time medical information to users upon request, at predetermined intervals, upon the occurrence of an event, and/or the like. In exemplary embodiments, the term “user” may generally refer to any party provided with access to the systems and methods in accordance with embodiments of the present invention. For example, a user may comprise a healthcare provider, a payer, a patient, a legal representative, and/or the like.

In exemplary embodiments, the interface module 144 may be adapted to provide the user with a means for interacting with the EMPASS 140. The interface module 144 may be adapted to present a graphical user interface (GUI) to the user, the GUI adapted to allow users to input, view, and interact with the EMPASS 140. In some embodiments, the interface module 144 may be adapted to present medical information to a user via a display on a computer, a tablet, a mobile device, a laptop, a touchscreen device, and/or the like. The interface module 144 may also be adapted to provide an opportunity to register a user account for accessing the EMPASS 140. User accounts may be restricted to authorized personnel and a verification of a user's identity, such as a social security number or an employee ID number, may be required. In some embodiments, user account requests must be approved by an administrator of the EMPASS 140 and/or may only be created by an administrator. The interface module 144 may be adapted to allow a user to run a search query on data stored in the database 142. The interface module 144 may also be adapted to allow a user to enter data into the data collection module 146.

In accordance with exemplary embodiments of the present invention, the interface module 144 may also allow a user to access medical data generated, filtered, and/or stored by the analysis and reporting module 148. The interface module 144 may be adapted to allow the user to run a report on the data contained in the database 142 with the analysis and reporting module 148 upon request, at predetermined intervals, or upon the occurrence of an event. For example, a user may access medical data upon running a report request with the interface module 144. The interface module 144 may also be adapted to transmit and/or display alert messages to the user when an event occurs and/or an alert is received from the analysis and reporting module 148. An event that triggers an alert may comprise, for example, data that indicates a likelihood of a medical error, a likelihood of a medical malpractice claim, a notification that a procedure is completed, and/or the like.

In exemplary embodiments, alerts may be presented to the user via a display on a computer or electronic device, via a text or SMS message, via an automated phone call, via email, via an auto-generated letter via postal mail. When an alert is generated, it may be sent to multiple parties. For example, if the analysis and reporting module 148 determines that an event or exception has occurred and an alert should be generated, an alert may be generated and sent via one or more communication means to the healthcare provider, the payer, the patient, a patient's designated family member, one or more legal representatives of any party, and/or the like. The interface module 144 may also be adapted to allow users who are granted sufficient permissions by the administrator to add, delete, and/or modify data saved in the system. Certain data may be completely restricted from modification or deletion, however, such as data received from medical test equipment or medical procedure recording equipment. The interface module 144 may also be customized by a user and/or an administrator. For example, the interface module 144 may be customized to display medical data in a customized visual format, at certain time intervals, upon the occurrence of an event, or upon request of a user and/or administrator.

In accordance with exemplary embodiments of the present invention, the data collection module 146 may be adapted to receive data from a device, such as a medical monitor, a medical instrument, a medical implant, an in vitro diagnostic device, a medical apparatus, any device used to diagnose, prevent, or treat a medical condition, any device to capture audio, video, motion, temperature, or air content data, and/or the like. In exemplary embodiments, medical data may comprise real-time monitoring data, data collected during a medical procedure, data in a patient's health record, and/or the like. For example, data in a patient's health record may comprise a patient's name, birth date, contact information, insurance information, health habit information, prior diagnosis, prior prognosis, test results, blood type, emergency contact, date of last physical, dates and results of tests and screenings, illnesses and surgeries with dates, list of medications and dosages and how long the patient has taken them, any allergies, any chronic diseases, any history of illnesses in the patient's family, notes made by healthcare providers, consultation notes, healthcare provider orders, copies of imaging and x-ray reports, lab reports, immunization records, consent and authorization forms, operative reports, pathology reports, discharge summaries, any information related to the care and treatment of a patient, and/or the like.

In accordance with exemplary embodiments, data received from devices via the data collection module during a medical procedure may include vital signs of the patient, video data, audio data, identity of those who entered and/exited the treatment area before and during the procedure, location of all parties in the treatment area over time, vital signs of healthcare professionals, ambient temperature and air composition, movement of medical instruments, utilization of medical instruments, identity of parties who handled each medical instrument during a medical procedure, administration of any medications, identity of those who administered any medications, patients vital signs in response to actions taken by healthcare professionals, any video, audio, motion, location, temperature, or data related to any action taken in a treatment area, and/or the like.

In some embodiments, the video data may be video recorded by one or more cameras fixed in the treatment area or carried on or near a healthcare professional, the patient, and/or on a medical instrument. The cameras may be motion sensitive and may follow designated individuals, designated instruments, designated movements, or focus on the area of designated sounds. In some embodiments, the cameras will be statically fixed and will point at the center of the treatment area. In exemplary embodiments, audio data may comprise any audio data captured by an audio capture device in the treatment room or carried with any healthcare professional and/or the patient, or the like.

In some embodiments, if the medical data collected is designated as essential by a user and/or administrator, the essential data is forwarded to the analysis and reporting module 148. In some embodiments, if the medical data collected is designated as non-essential by a user and/or administrator, the non-essential data is not forwarded to the analysis and reporting module 148 and is saved in the database 142 without further analysis. In accordance with exemplary embodiments, the database 142 may be adapted to store all medical data in accordance with the present invention.

In accordance with exemplary embodiments of the present invention, the analysis and reporting module 148 may be adapted to analyze medical data collected by the data collection module. The analysis and reporting module 148 may be adapted to apply one or more algorithms or sets of rules against data collected by the data collection module 146. The analysis and reporting module 148 may be adapted to use predictive coding to find responsive document(s) or event(s). For example, the analysis and reporting module 148 may be adapted to find and/or identify data that indicates a high likelihood of a successful malpractice claim of a patient against the healthcare provider.

The analysis and reporting module 148 may be adapted to flag and identify potential liability risks and present the risk(s) to a user and/or administrator via an alert, a report, or upon request from the user and/or administrator. The analysis and reporting module 148 may compare the collected medical data with best practices data indicating a range of proper treatments for given set of medical data. Best practices data may generally be set by medical practice standards boards, by healthcare providers, by payers, and/or the like. If the collected medical data does not fall within the best practices data ranges, an indication that medical error has occurred may be generated and an alert reporting a high likelihood of success of a medical malpractice lawsuit may be generated. When a known medical error condition is met, the analysis and reporting module 148 may be adapted to notify the user and/or administrator via the interface module 144. The analysis and reporting module 148 may also be adapted to generate reports and/or alerts comprising a summary of all patients, any error conditions for specific patients and/or the like. The reports and/or alerts may be transmitted and/or displayed to the user via text or SMS message, mobile communication device, email, postal mail, a report generated on the display of a computing device, and/or the like.

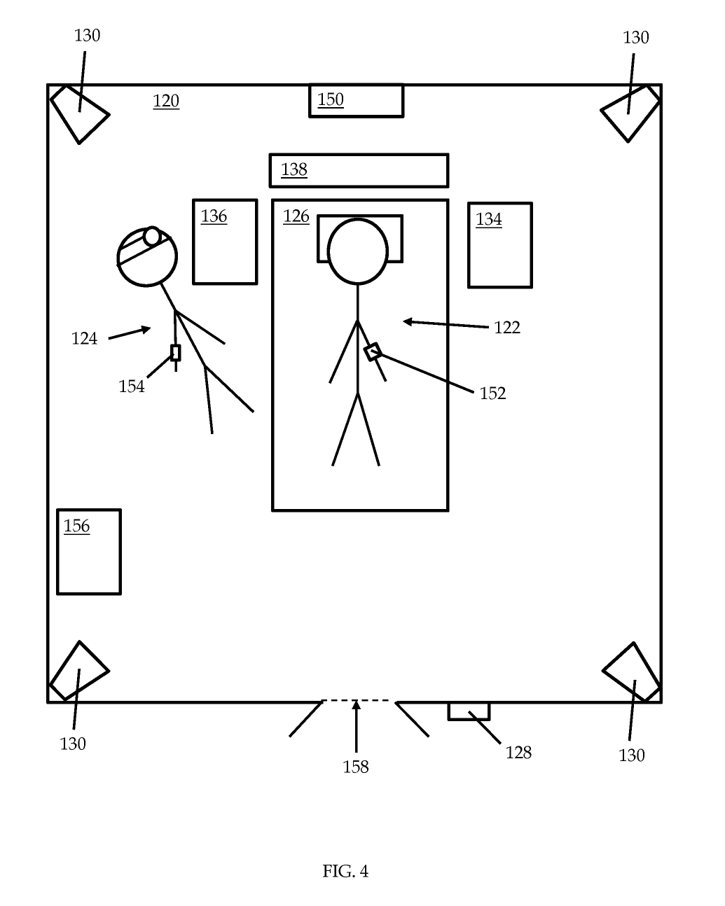

FIG. 4 depicts a top view of a treatment area 120 in accordance with embodiments of the present invention. A treatment area 120 may comprise any location in which a patent 122 is treated and/or evaluated for a medical condition by a healthcare provider 124. For example, a treatment area 120 may comprise a hospital emergency room, an operating room, a hospital room, a medical office treatment room, a medical tent, a medical clinic, a pharmacy, a test laboratory, a medical school, a triage area, and/or the like. In some embodiments, the patient 122 may be treated on a treatment surface 126, such as an operating table, a bed, a mattress, or the like. The treatment surface 126 may comprise data collection devices or data collection members or may be coupled with data collection devices or data collection members. For example, the treatment surface 126 may comprise an operating table, a bed, a mattress, or the like. The treatment surface 126 may comprise one or more data collection devices, for example, a scale for weighing the patient, and/or a blood pressure cuff for measuring the blood pressure of the patient 122.

In accordance with exemplary embodiments a treatment area 120 may comprise data collection devices adapted to collect data and/or transmit the data to the analysis and reporting module 148. In some embodiments, data collection devices may comprise one or more access members 128, video members 130, medical monitors 134, medical instruments 136, audio members 138, motion members 150, patient monitors 152, provider monitors 154, additional instruments 156, any device used to diagnose, prevent, or treat a medical condition, any device to capture audio, video, motion, temperature, or air content data, and/or the like. In exemplary embodiments each of the data collection devices may be adapted to collect data and/or transmit data to the analysis and reporting module 148 or any module in accordance with the present invention. In some embodiments, the data collection devices/members may comprise manual or mechanical devices to be read by a healthcare provider 124 and input manually into the system, or the like.

In some embodiments, access to the treatment area 120 may be restricted to certain providers 124 and patients 122. An access member 128 may be provided to restrict access to the entrance 158 of the treatment area 120 to authorized personnel and patients. The authorized personnel may be configured by a user of the system and/or by an administrator. The access member 128 may be configured to restrict access to the treatment area 120 by locking or permitting access to the entrance 158 until security data is received. In exemplary embodiments, security data may be a password, a fingerprint scan, a retina scan, an audio identification of the user's voice, an RFID badge, a swipe card, a security token, a combination thereof, and/or the like. Once the user is authenticated, the access member 128 may grant the authenticated personnel or patient access to the treatment area 120 and store the identity of each user entering the room and the associated dates and times of entry. After entrance to the room, if a user is to leave the room, they may be required to log out of the room using the access member 128, or the access member 128 may be adapted to identify all users leaving the room with an RFID reader, or the like.

In accordance with exemplary embodiments of the present invention, the video member 130 may comprise a device adapted to receive and/or record a video signal. For example, the video member 130 may comprise a video camera, a still camera, a time-lapse camera, a night vision camera, and/or the like. Although four video members 130 are depicted, any number of cameras adapted to capture the medical procedure in the treatment room 120 without obstructed views may be used, or the like. For example, one, two, three, four, eight, or sixteen video members 130 may be used. In some embodiments, the video members 130 may be attached to and or integral with the medical instruments 136 and/or medical monitors 134. In some embodiments, video members 130 may be worn and/or attached to the provider 124 and/or the patient 122. For example, the provider 124 may wear a headband comprising a video member 130. In some embodiments, the video members 130 may be static and fixed on a single viewpoint. In other embodiments, video members 130 may be moveable via mechanical or electronic means by a user, or may be motion activated and may be adapted to focus on the areas of the treatment area 120 where motion is occurring. In some embodiments, a dedicated video member 130 may be adapted to follow one or more specific medical instruments 136. In some embodiments, one or more of the video members 130 may be fixed and one or more video members 130 may be motion activated.

In accordance with exemplary embodiments of the present invention, a medical monitor 134 may be adapted to collect data regarding the health condition of the patient. For example a medical monitor 134 may comprise a bedside monitor, a vital sign monitor, a blood glucose monitor, a heart rate monitor, a blood pressure monitor, an oxygen monitor, a glucose meter, a telemetry device, a biotelemetry device, a cardiac monitor, a hemodynamic monitor, a respiratory monitor, a neurological monitor, a childbirth monitor, a body temperature monitor, a device adapted to collect medical data, a device adapted to collect data regarding the conditions, temperature, and/or air composition of the treatment area 120, and/or the like. In some embodiments, the medical monitor 134 may comprise a single monitor or several monitors adapted to capture data and transmit the data to any module in accordance with the present invention, or the like.

In some embodiments of the present invention, a medical monitor 134 may be coupled with a patient monitor 152 comprising a sensor for monitoring the medical condition of the patient 122. The patient monitor 152 may comprise a blood pressure cuff, an oximeter, a heart rate monitor, any device adapted to collect medical information from the patient 122, and/or the like. In some embodiments, the system may also include a provider monitor 154 for monitoring the health conditions of the healthcare provider 124. For example, if the provider 124 suffers a medical event, such as a stroke or a seizure, the provider monitor 154 may capture the health conditions of the provider 134 and correlate it with what actions occurred in relation to the patient 122 during the same time period. The provider monitor 154 may also be used to monitor the providers stress levels and to ensure the provider is not intoxicated by measuring blood alcohol content of the provider 124.

The patient monitor 152, the provider monitor 154, and/or the medical monitor 134 may be adapted to record medical data over time. The monitors 152, 154, 134 may comprise a translating component responsible for converting the signals from the sensors into a format that can be read by a display and or any module in accordance with the present disclosure. The monitors 152, 154, 134 may comprise a display and/or output device adapted to display the medical data and/or transmit the medical data to a second device and/or any module in accordance with the present invention. The monitors 152, 154, 134 may comprise communication links adapted to transmit output to a central monitoring station and/or any module in accordance with embodiments of the present invention.

In some embodiments, the system may also comprise wristbands or other identification means with bar codes, RFID chips, or other identifiers. In some embodiments, when an action is taken the identification means may be scanned. For example, when a medication is administered to a patient 122, the medication container may comprise a bar code or an RFID chip, or the like, and may be scanned. The identification means of the patient 122 may also be scanned to identify that the patient 122 is receiving the scanned medication. The identification means of the provider 124 may also be scanned to identify the provider 124 administering the scanned medication to the scanned patient 122, or the like. The identification means may also be scanned when certain medical instruments 136 are used.

In accordance with exemplary embodiments of the present invention, medical instruments 136 may be sterilized and prepared for use in a medical procedure. A medical instrument 136 may comprise any device adapted for use in a medical procedure. In accordance with exemplary embodiments, a medical instrument 136 may comprise an RFID chip and/or a bar code for scanning before use to identify which provider 124 is handling and or utilizing the medical instrument 136. In some embodiments of the present invention, the scanning of RFID chips and/or bar codes is done manually by the provider 124 at each step. In alternative embodiments of the present invention, the scanning of RFID chips and/or bar codes is done automatically and detected by motion and a provider's 124 physical proximity to an instrument 136. In some embodiments of the present invention, the angles and position of medical instruments 136 may be recorded by sensors in the instruments 136 or in another location in the treatment area 120. By way of example, if a scalpel is used, the angle of the scalpel when making an incision may be recorded. In accordance with embodiments of the present invention, if the angle of the scalpel is too steep or too shallow when compared with an ideal range, or if the scalpel is moved too quickly when compared with an ideal range of speed, or if the depth of the incision is to deep or not deep enough, an error message or potential medical error alert may be generated by the analysis and reporting module of a system in accordance with embodiments of the present invention. The proper use of medical instruments 136 may be evaluated by certain thresholds determined by a user, the administrator, and/or the like. If the system detects a medical instrument is or was used improperly, the system will generate an alert, or the like. The same holds true for additional instruments 156, which may be used in the event of complications of a medical procedure or unexpected medical conditions.

In some embodiments of the present invention, an audio member 138 may comprise a device adapted to record audio. In some embodiments, multiple audio members 138 may be positioned around the treatment room. In some embodiments, the audio members 138 may be motion or sound sensitive, and may focus on areas in which sound and/or motion is occurring. In some embodiments, the provider 124 and/or the patient 122 may be monitored with an audio member 138 to determine if any potential medical errors have occurred. By way of example, if a patient 124 utters the phrase “oh my knee” or “my chest hurts” and the provider 124 does not respond with an appropriate treatment, a medical error alert, or the like, may be generated. Further, if a provider utters “oh no!” or “whoops!”, or the like, a medical error alert, or the like may be generated. In some embodiments, medical conditions, such as the patients breathing sounds, or heartbeat sounds, may be monitored and transmitted to any module in accordance with embodiments of the present invention.

In some embodiments, a system may include a motion member 150 adapted to monitor the motion of the provider 124 and the patient 122. In some embodiments, the motion member 150 may be adapted to identify the location of all providers 124 in the treatment area and their movements over time. The motion member 150 may be adapted to monitor the movements of the patient 122 during the medical procedure. Although one motion member 150 is depicted in the figure, multiple motion members 150 may be included. The motion member 150 may also be adapted to monitor, save, and transmit the speed of movement of the providers 124 and the patient 122.

In exemplary embodiments of the present invention, the system may be adapted to compare all data collected during a medical procedure against best practices and procedures established by a medical governing body, a healthcare provider, a payer, and/or the like. When the system analyzes the data and identifies that a provider 124 operated outside of the identified best practices, an alert or the like, may be generated. In some embodiments, the alert may be generated in real-time to notify the doctor before a severe mistake occurs that may negatively affect the outcome of the medical procedure. In some embodiments, the alerts are only presented upon request of a user, after a procedure is complete, at predetermined time intervals, or the like. In some embodiments, an alert may only be sent to selected individuals, such as a hospital administrator and/or a legal representative. In some embodiments, all parties involved in the medical procedure may receive the alert. In some embodiments, the system may allow the provider 124 to enter notes and/or comments after the procedure to explain any medical alerts that may have been generated and the reasoning and/or explanations for any potential areas of malpractice liability and any potential medical errors.

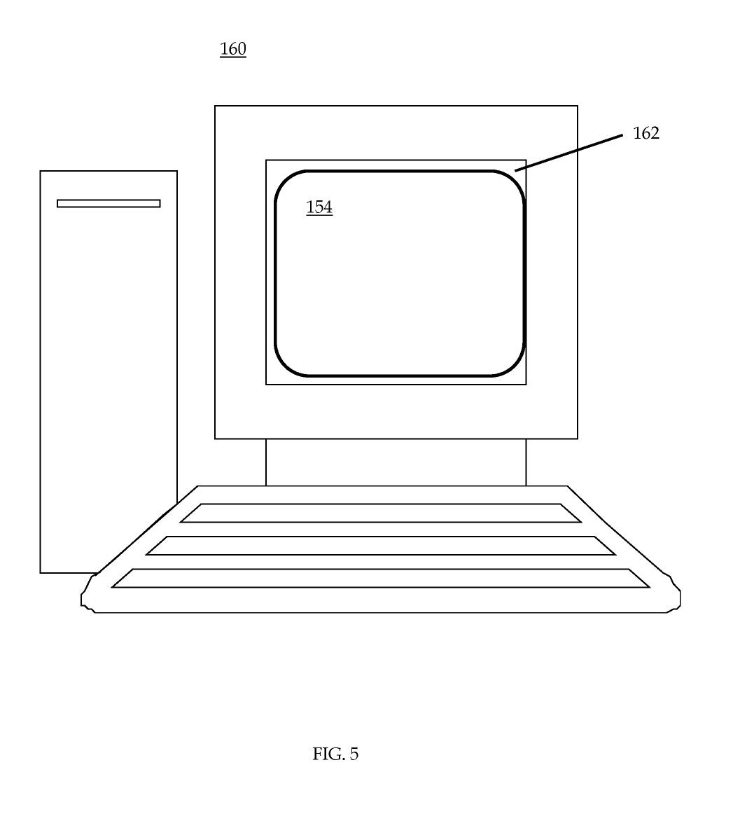

FIG. 5 depicts an exemplary client 160 capable of being used with the system depicted in FIG. 1, in accordance with embodiments of the present disclosure. In exemplary embodiments, the client computer 160 may comprise a display 162. The display 162 may be adapted to display at least an interface 154. In exemplary embodiments, the functionality and appearance of the display may be determined by an interface module. The interface 154 may be adapted to display any data and analysis collected, stored, and/or analyzed by a system in accordance with embodiments of the present invention. Although a client computer 160 is depicted as a personal computer in FIG. 5, any computing device may be used. By way of example, a mobile phone, a tablet computer, a laptop computer, and/or the like may be used, to name a few.

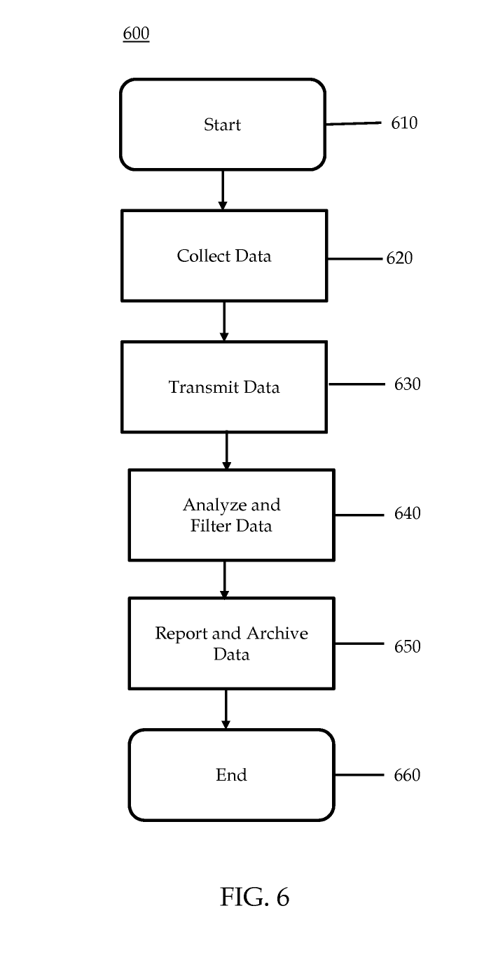

FIG. 6 depicts a flow diagram illustrating an exemplary method for electronic medical data processing, analysis, and storage in accordance with embodiments of the present invention. In exemplary embodiments, the computer-implemented method 600 may comprise collecting, transmitting, analyzing, filtering, reporting, and/or archiving medical data. The method 600 may be carried out using the architecture and components described in the systems above, or may utilize any other type of system architecture suitable for embodiments of the present invention. It should further be appreciated, the steps of method 600 may be carried out in any order (e.g., step 630 may occur before step 620), unless otherwise explicitly specified by the steps of the exemplary method. For ease, exemplary methods represented in FIG. 6 are described with reference to the client 105, server 115, and EMPASS 140 described above. The method 600 may be carried out using other embodiments as well. Many steps of the method 600 may generally be carried out by the EMPASS 140. The EMPASS 140 may be stored on a client 105, a server 115, or any other data storage location consistent with the present disclosure. It will be appreciated that the steps of the method 600 may be performed exclusively on the client 105 or partially on the client 105 and partially on the server 115. Any combination of shared computing power for performing the steps of the methods described herein consistent with the present disclosure is contemplated. For example, multiple clients 105 and servers 115 may collaborate to perform the steps of method 600.

The method 600 begins at step 610. At step 620, data is collected during a medical procedure in accordance with embodiments of the present invention. Data may be collected during the medical procedure by use of a medical data collection device. Examples of medical data collection devices and/or data collection members are described with respect to FIG. 3 above. For example, medical data collection devices may include a treatment surface 126, an access member 128, a video member 130, a medical monitor 134, a medical instrument 136, an audio member 138, a motion member 150, a patient monitor 152, a provider monitor 154, an additional instrument 156, any device used in a medical procedure, and/or the like. At step 630, after the data is collected by one or more medical data collection devices, the data may be transmitted to and received by the data collection module. The data collection module may coordinate, receive, and sort all data received from the medical data collection devices. The data collection may send data designated as essential according to predetermined criteria to an analysis and reporting module, and may send data designated as non-essential data to a database for archiving.

At step 650, data is received by the analysis and reporting module for analysis. In accordance with exemplary embodiments, the received data is compared against predetermined parameters indicating best practices in medicine. A series of instructions and/or algorithms may be executed by a computer, or the like, and applied against the received data. The system may employ the use of predictive coding to find responsive documents, events and/or data. If a condition is met that identifies a potential risk of a successful medical malpractice lawsuit, a medical error alert, or the like, may be generated. The medical error alert, or the like, may be printed in a report, displayed on a computer screen via an interface, or the like, transmitted via email, transmitted via text message, and/or stored in a database in accordance with embodiments of the present invention. After the procedure has concluded and all alerts, if any, have been generated by the system and transmitted to appropriate individuals, groups, and/or companies, the method 600 ends at step 660.

While the foregoing is directed to embodiments of the present disclosure, other and further embodiments of the disclosure may be devised without departing from the basic scope thereof. It is also understood that various embodiments described herein may be utilized in combination with any other embodiment described, without departing from the scope contained herein. In addition, embodiments of the present disclosure are further scalable to allow for additional clients and servers, as particular applications may require.

What is claimed is:

1. A computer-implemented method for collecting and analyzing medical data, the method comprising:
at a server having one or more processors and memory storing one or more programs for execution by the one or more processors:
receiving medical data related to a medical procedure from a data collection member;
comparing the medical data with a range of best practices data;
determining if the received medical data conforms to the range of best practices data;
generating an alert if the medical data does not conform to the range of best practices data; and
storing the medical data in a database.

2. The method of claim 1, wherein the data collection member comprises at least one of a video member, an audio member, a medical monitor, a treatment surface, an access member, a medical instrument, a motion member, a patient monitor, and a provider monitor.

3. The method of claim 2, wherein the medical monitor comprises at least one of a bedside monitor, a vital sign monitor, a blood glucose monitor, a heart rate monitor, a blood pressure monitor, an oxygen monitor, a glucose meter, a telemetry device, a biotelemetry device, a cardiac monitor, a hemodynamic monitor, a respiratory monitor, a neurological monitor, a childbirth monitor, and a body temperature monitor.

4. The method of claim 1, wherein the medical data comprises at least one of a video data, audio data, body temperature data, pulse rate data, blood pressure data, respiratory rate data, and oxygen level data.

5. The method of claim 4, wherein video data comprises a video recording of at least a portion of the medical procedure recorded with at least one camera.

6. The method of claim 4, wherein audio data comprises an audio recording of at least a portion of the medical procedure recorded with at least one audio recorder.

7. The method of claim 1, further comprising transmitting the alert to a client.

8. A computer-implemented method for collecting and analyzing medical data, the method comprising:
at a client having one or more processors and memory storing one or more programs for execution by the one or more processors:
receiving medical data related to a medical procedure from a data collection member;
comparing the medical data with a range of best practices data;
determining if the received medical data conforms to the range of best practices data;
generating and displaying an alert if the medical data does not conform to the range of best practices data; and
transmitting medical data to a server for storage on a database.

9. The method of claim 8, wherein the data collection member comprises at least one of a video member, an audio member, a medical monitor, a treatment surface, an access member, a medical instrument, a motion member, a patient monitor, and a provider monitor.

10. The method of claim 9, wherein the medical monitor comprises at least one of a bedside monitor, a vital sign monitor, a blood glucose monitor, a heart rate monitor, a blood pressure monitor, an oxygen monitor, a glucose meter, a telemetry device, a biotelemetry device, a cardiac monitor, a hemodynamic monitor, a respiratory monitor, a neurological monitor, a childbirth monitor, and a body temperature monitor.

11. The method of claim 8, wherein the medical data comprises at least one of a video data, audio data, body temperature data, pulse rate data, blood pressure data, respiratory rate data, and oxygen level data.

12. The method of claim 11, wherein video data comprises a video recording of at least a portion of the medical procedure recorded with at least one camera.

13. The method of claim 11, wherein audio data comprises an audio recording of at least a portion of the medical procedure recorded with at least one audio recorder.

14. The method of claim 13, wherein when the audio recording exceeds a predetermined decibel level, an alert is generated and displayed to a user.

15. A system comprising at least one server, the server comprising:
one or more processors; and
memory;
wherein the at least one server is configured to:
receive medical data related to a medical procedure from a data collection member;
compare the medical data with a range of best practices data;
determine if the received medical data conforms to the range of best practices data;
generate an alert if the medical data does not conform to the range of best practices data; and
store the medical data in a database.

16. The system of claim 15, wherein the data collection member comprises at least one of a video member, an audio member, a medical monitor, a treatment surface, an access member, a medical instrument, a motion member, a patient monitor, and a provider monitor.

17. The system of claim 16, wherein the medical monitor comprises at least one of a bedside monitor, a vital sign monitor, a blood glucose monitor, a heart rate monitor, a blood pressure monitor, an oxygen monitor, a glucose meter, a telemetry device, a biotelemetry device, a cardiac monitor, a hemodynamic monitor, a respiratory monitor, a neurological monitor, a childbirth monitor, and a body temperature monitor.

18. The system of claim 15, wherein the medical data comprises at least one of a video data, audio data, body temperature data, pulse rate data, blood pressure data, respiratory rate data, and oxygen level data.

19. The system of claim 18, wherein video data comprises a video recording of at least a portion of the medical procedure recorded with at least one camera.

20. The system of claim 18, wherein audio data comprises an audio recording of at least a portion of the medical procedure recorded with at least one audio recorder.
